(19) United States
(12) Patent Application Publication
(10) Pub. No.: US 2008/0112698 A1
(43) Pub. Date: May 15, 2008

(54) Camera for a weapon and methods for doing the same

(76) Inventor: Craig Ray, Troy, OH (US)

Correspondence Address: DINSMORE & SHOHL LLP;One DaytonCentre, Suite 1300, One South Main Street, Dayton, OH, 45402-2023, US

(21) Appl. No.: 11/316,611

(22) Filed: Dec. 22, 2005

(51) Int. Cl. G03B 17/00

(52) U.S. Cl. 396/56

(57) ABSTRACT

A camera system for use with a weapon includes a camera, a lens assembly separate from the camera, and a mount attached to the lens assembly for mounting the lens assembly to a weapon. The camera includes a body, a wireless receiver disposed along the body, and a storage medium in communication with the receiver. The lens assembly comprises a wireless transmitter for transmitting signals from the lens assembly to the receiver. The camera system may include a sensor connected to the lens assembly for detecting a change in the position of the lens assembly from a non-shooting position to a shooting position and for activating the camera system based upon detection of this change in positions.

### FIELD OF THE INVENTION

The present invention generally relates to a camera for a weapon and methods for doing the same. More particularly, the present invention relates to a video camera configured to be at least partially mounted to a weapon such as a firearm or bow and to be actuated when the weapon is moved to a firing orientation.

### BACKGROUND OF THE INVENTION

Video cameras attached to the end of a weapon such as a barrel of a gun is known. However, generally the entire video camera has been attached to the weapon, which includes the lens, storage medium, controls, and microprocessor. This generally made the weapon heavier and bulkier than desired, especially on the end such as a barrel of the weapon. In addition, the user had to either leave the camera “on” the entire time or turn the camera “on” right before firing in order to film what the user was firing at and objects that were in the general firing range of the weapon. The former wasted the battery of the camera and the latter caused a distraction and delay to the user in firing the weapon.

Accordingly, there is a need for an improved camera, especially a video camera, for a weapon and methods for doing the same.

### SUMMARY OF THE INVENTION

Accordingly, the present invention is intended to address and obviate problems and shortcomings and otherwise improve previous cameras for a weapon and methods for doing the same.

One exemplary embodiment of the present invention is a camera system for use with a weapon. The camera system includes a camera, a lens assembly separate from the camera, and a mount attached to the lens assembly for mounting the lens assembly to a weapon. The camera comprises a body, a wireless receiver disposed along the body, and a storage medium in communication with the receiver. The lens assembly comprises a wireless transmitter for transmitting signals from the lens assembly to the receiver.

Another exemplary embodiment of the present invention is a video camera system for use with a weapon. The video camera system includes a video camera, a lens assembly separate from the video camera, and a mount attached to the lens assembly for mounting the lens assembly to a weapon. The video camera includes a body, a storage medium, and a first wireless transceiver in communication with the storage medium. The lens assembly includes a housing, a lens connected to the housing, a microphone attached to the housing, and a second wireless transceiver in communication with the lens and microphone in order to send and receive respective video and audio signals. The first and second transceivers are operable to wirelessly transmit and receive video, audio, and control signals between the video camera and the lens assembly.

Yet another exemplary embodiment of the present invention is a video camera system in combination with a weapon that includes a weapon, a lens assembly removably mounted to the weapon, and a video camera separate from the lens assembly. The lens assembly includes a lens and a first wireless transceiver in communication with the lens. The video camera includes a second wireless transceiver and a storage medium in communication with the second transceiver. The first and second transceivers wirelessly transmit and receive signals between the lens assembly and the video camera in order to video objects within the viewing range of the lens.

### BRIEF DESCRIPTION OF THE DRAWINGS

While the specification concludes with claims particularly pointing out and distinctly claiming the invention, it is believed the same will be better understood from the following description taken in conjunction with the accompanying drawings in which:

FIG. 1 is a schematic representation of an exemplary embodiment of the video camera for a weapon according to the present invention;

FIG. 2 is a front view of the lens assembly of the video camera illustrated in FIG. 1;

FIG. 3 is a top view of the lens assembly of the video camera illustrated in FIG. 1;

FIG. 4 is a schematic representation of an exemplary embodiment of a video camera system in combination with a hand gun according to the present invention;

FIG. 5 is a graphical representation of an exemplary embodiment of shooting and non-shooting positions according to the present invention; and

FIG. 6 is a perspective view of another exemplary embodiment of a lens assembly according to the present invention.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION OF THE INVENTION

Reference will now be made in detail to various exemplary embodiments of the invention, examples of which are illustrated in the accompanying drawings, wherein like numerals indicate similar elements throughout the views.

For illustration purposes only, and not limitation, the camera of the present invention is shown and described as a video camera. However, it is understood that other conventional cameras, such as analog and digital still cameras (e.g., 35 mm, SLR, etc.), analog and digital video cameras and/or recorders, or digital cameras capable of taking both still and video images, may be used with the present invention as known to one of ordinary skill in the art. In addition, it should be understood that the camera of the present invention may be an analog or digital camera.

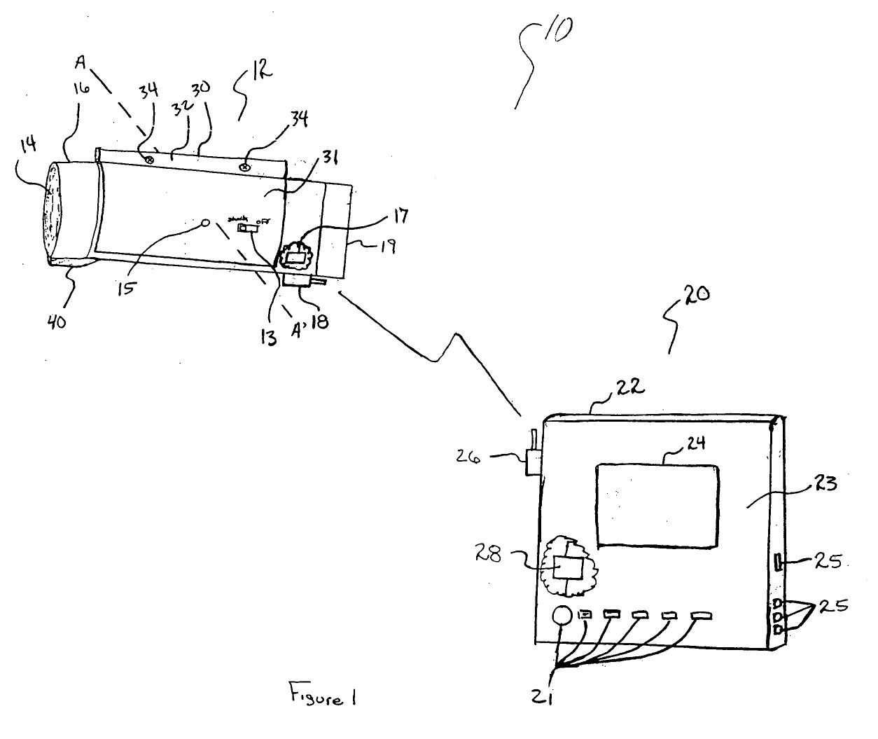

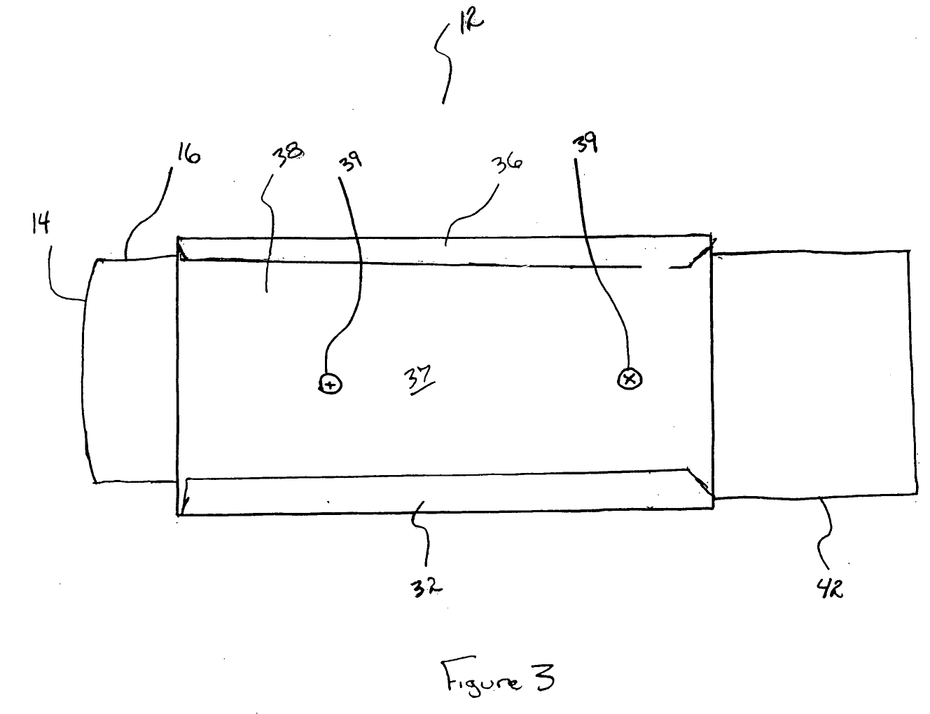

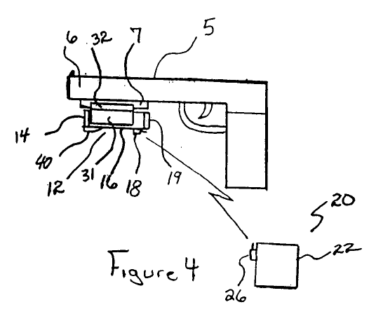

Referring to FIGS. 1-5, an exemplary embodiment of a video camera system 10 for use with a weapon 5 according to the present invention is shown. Weapon 5 may include, but not be limited to, a pistol/hand gun, rifle, shotgun, bow, crossbow, or any other conventional weapon. Video camera system 10 generally includes a lens assembly 12 and a camera 20 separate from lens assembly 20. Lens assembly 12, may be mounted to a weapon such as an under-carriage 7 of a barrel 6 of gun 5 (FIG. 4), and camera assembly 20 may be attached to or held by an operator of the weapon.

In the exemplary embodiment, lens assembly 12 includes a lens 14 contained within a housing 16 and a lens transmitter 18 attached to the housing 16. Lens transmitter 18 is in communication with lens 14 and is configured to receive image data signals (e.g., still and/or video) and control signals from lens 14 and transmit these signals to camera 20 to be stored, recorded, and/or played by the camera. Lens assembly 12 may include a power source 19 in electrical communication with lens 14 and/or lens transmitter 18 to power the functionality of the two components. Power source 19 may be any conventional type of power sources such as battery, solar, etc., as known to one of ordinary skill in the art.

Lens 14 may be any conventional lens used in cameras and/or video cameras as known to one of ordinary skill in the art. Lens 14 may optionally be a zoom lens having adjustable magnification. The zoom function may be manual, automatic, or any combination thereof. Lens 14 may also include a manual or auto focus function enabling camera 10 to be manually or automatically focused on objects that are within the viewing range of lens 14 and thus being videoed or photographed. Both the auto focus and zoom functions of lens assembly 12 and/or lens 14 may be conventional systems and may also be controlled by a micro-processor/controller connected to lens assembly 12 and/or camera assembly 20 as known to one of ordinary skill in the art. In addition, both the auto focus and zoom functions may derive its power from power source 19.

Video camera system 10 may also include a microphone 40 in communication with the video camera 20. In the exemplary embodiment shown, microphone 40 is connected to housing 16 of lens assembly 12. Microphone 40, in the exemplary embodiment, is in communication with transmitter 18 and/or power source 19. Microphone 40 captures audio (sounds) and transmits audio signals to transmitter 18, which in turn, wirelessly transmits these audio data signals to video camera 20 to be stored, recorded, and/or played via speakers. Microphone 40 may be any type of conventional microphone as known to one of ordinary skill in the art. It may be connected to an optional signal processor located on lens assembly 12 as set forth above.

Lens transmitter 18 may be any conventional transmitter such as a wireless transmitter, radio, and/or transceiver. As used herein, transmitter is defined as a transmitter, radio, or transceiver that is capable of transmitting and/or receiving data and control signals. Such signals may include, but not be limited to, audio, text, control, still image data, and/or video image data as known to one of ordinary skill in the art. Lens assembly 12 may also include a lens signal processor (not shown) in order to receive and process the signals transmitted between lens assembly 12 and video camera 20.

In the exemplary embodiment, lens assembly 12 may include a switch 13 that includes two positions: a “Off” position; and a “Standby” position as shown in FIG. 1. In addition, lens assembly 12 may include an indicator 15 such as a LED light to indicate when video camera system 10 is in the standby mode, i.e., manual switch 13 is in the “Standby” position. When switch 13 is in the “off” position, lens assembly 12 may be configured such that it will not capture video (or take still) images and/or audio and transmit those video and/or audio signals to video camera assembly 20. Video camera system 10 may be configured such that when switch 13 is moved to the “Standby” position, video camera system 10 requires minimal intervention or action by the operator to activate the video camera system 10. As used herein, “Activate video camera system 10” is defined as starting the videoing and/or recording (or taking of still pictures) of objects within the viewing range of lens 14 by video camera system 10.

In one exemplary embodiment, once switch 13 is in the “Standby” position, the operator only has to manipulate a “Record” control button located with other optional conventional video camera control buttons 21 to activate video camera system 10. However, it has been found that it is desirable to make video camera system 10 as “hands free” as possible, i.e., minimal requirements for the operator to separately activate the videoing of the video camera system. Such “hands free” operations reduces unnecessary distractions such as having to press buttons to activate the video camera system from the task of shooting at a target. The reduction in distractions from the task of shooting increases the operators focus and shooting accuracy while still providing videoing capabilities.

Video camera system 10 may include a sensor capable of detecting contact, light, or motion of either lens assembly 12 (and/or weapon 5 that lens assembly 12 is mounted to) or of objects within the viewing range of lens 14. Such a sensor may be any conventional sensor as known to one of ordinary skill in the art. The sensor may be connected to an electrical circuit of video camera system 10, which may include, but not be limited to, switch 13, power source 19, a signal processor, and transmitter 18. The sensor may be disposed along lens assembly 12 or weapon 5. The sensor may be configured such that it activates video camera system 10, if switch 13 is in the “Standby” position, and the sensor detects, for example, contact against the sensor, light, or motion.

In an exemplary embodiment, video camera system 10 may include a contact sensor (not shown) positioned along a trigger of a gun or a handle of a hand gun such that when an operator places a finger on the trigger before firing the gun or grabs the handle of the gun, respectively, the contact sensor detects the operator's finger or hand. When it detects the operator's finger or hand, the contact sensor signals video camera system 10, which activates videoing of objects within the viewing range of lens 10.

In another exemplary embodiment, the sensor may comprise a light or motion sensor 155 attached to lens assembly 12. The sensor may be located along lens assembly 12, for example, near lens 14 of housing 16, in order for the holster to prevent the sensor from detecting any light or motion of objects (either in front of the lens assembly or the lens assembly itself). However, when the hand gun is removed from the holster, the motion sensor will detect light or motion of objects within the range of detection of the motion sensor as the hand gun is moved from the holster to an un-holstered position such as a firing position. Alternatively, the sensor may comprise a contact sensor (e.g., a magnetic contact switch/sensor) that is configured to detect when the hand gun is in the holster and/or out of the holster and activate videoing when the hand gun is out of the holster.

In yet another exemplary, lens assembly 12 may be mounted on a weapon such as a bow 165 and switch 13 is in the “Standby” position, if the operator moves the bow such as from a non-shooting to a shooting position, such movement will activate or begin videoing of any objects within the viewing range. Video camera system 10 may include a time delay such that the video camera system 10 does not activate when the motion sensor detects minor movements (e.g., minor shifting of the bow) but does activate when the motion sensor detects more sustained movements over a specified period of time (e.g., moving the bow from a non-shooting to a shooting position. Such configuration would also work if video camera system 10 is mounted to a hand gun/pistol, rifle, cross bow, or other weapon.

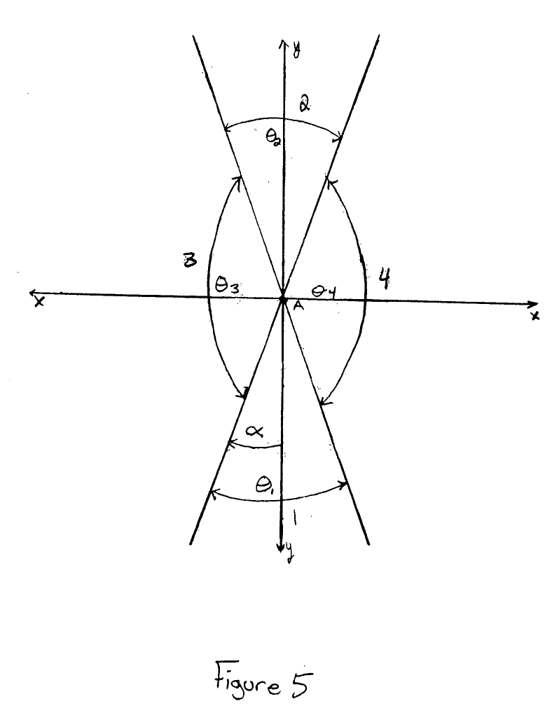

In the exemplary embodiment shown in FIGS. 1-5, the sensor of lens assembly 12 is a mercury switch 17 configured to detect a partial rotation at an angle of rotation a of lens 175 assembly 12 (and/or hand gun 5) about a latitudinal axis A-A′ and then to activate video camera system 10 based upon this detected rotation. FIG. 5 shows a horizontal axis X and a vertical axis Y perpendicular to the X axis. The latitudinal axis A-A′ of lens assembly 12 (and/or hand gun 5) is shown at the intersection of the X and Y axes. FIG. 5 also shows ranges wherein hand gun 5 (and/or mounted lens assembly 12) is in a non-shooting position (ranges 1 and 2) and ranges wherein hand gun 5 (and/or mounted lens assembly 12) is in a shooting position (ranges 3 and 4). As used herein, if hand gun 5 and/or mounted lens assembly 12) is in a non-shooting position, then barrel 6 and/or mounted lens 14 are either pointing substantially downward within range 1 or pointing substantially upward within range 2. Non-shooting range 1 is equal to Θ₁, wherein Θ₁, may range from about 90° or less. Non-shooting range 2 is equal to Θ₂, wherein Θ₂ may range from about 90° or less. Shooting range 3 is equal to Θ₃, wherein Θ₃ may range from about 120° to about 90°. Also, Shooting range 4 is equal to Θ₄, wherein Θ₄ may range from about 120° to about 90°. It is understood that ranges 1 and 2 may have different or equal angles of rotation about axis A-A′ and that ranges 3 and 4 may have different or equal angles of rotation about axis A-A′. In the exemplary embodiment shown in FIG. 5, Θ₁ and Θ₂, both equal about 60°, and Θ₃ and Θ₄, both equal about 120°.

In the exemplary embodiment shown in FIGS. 1-5, mercury switch 17 is electrically connected to the video camera system's circuit and configured to activate video camera 10 if switch 13 is in the “Standby” position and once hand gun 5 (and lens assembly 12) has rotated about latitudinal axis A-A equal to or greater than α. Mercury switch 17 may be configured to activate video camera system 10 at any angle of rotation α about latitudinal axis A-A′, including but not limited to an angle of rotation a of equal to or greater than about 5°, equal to or greater than about 15°, equal to or greater than about 30°, equal to or greater than about 45°, or any other angle of rotation. For illustration purposes only, and not limitation, video camera system 10 may be configured such that when hand gun 5 (and lens assembly 12) is in a non-shooting position such as within range 1 with barrel 6 pointing substantially downward and switch 13 is in the “Standby” position, mercury switch 17 would be open and thus video camera system 10 would not be activated (not videoing and/or recording).

However, video camera system 10 would activate when hand gun 5 (and lens assembly 12) is rotated about latitudinal axis A-A′ at an angle of rotation equal to or greater than a from non-shooting position range 1 to a shooting position range 3. In other words, when hand gun 5 is in a holster (range 1), video camera system 10 is not videoing. However, when hand gun 5 is un-holstered and moved to a shooting position (range 3 or range 4), video camera system 10 would begin videoing any objects/activity within the viewing range of lens 14. Such a video camera system 10 is desirable for mounting to police pistols/hand guns because they would begin videoing as soon as the officer partially rotates the pistol/hand gun from its holstered position to a firing position. In this exemplary embodiment, a equals 30°. In another exemplary embodiment, α equals 40°.

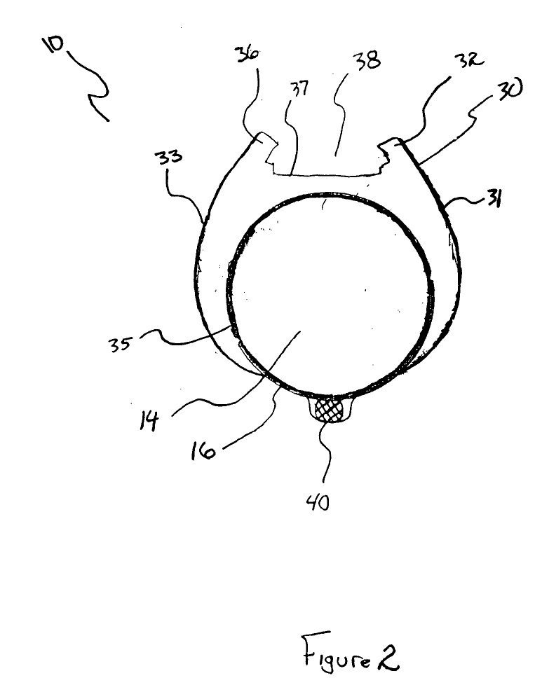

Video camera system 10 may also include a mounting device 30, which is configured to removably mount lens assembly 12 to weapon 5. In the exemplary embodiment, mounting device 30 includes first and second side panels 31 and 33 that are partially curved such that they form a substantially cylindrical space 35 in order to receive housing 16 of lens assembly 12. As shown in FIGS. 1 and 2, first and second side panels 31 and 33 may partially encompass housing 16. Mounting device 30 also may include a bottom panel 37 and first and second rails 32 and 36 that are connected to first and second side panels 31 and 33, respectively. First and second rails 32 and 36 and bottom panel 37 form a substantially U-Shaped channel 38 that is configured to receive and/or connect to a weapon. Bottom panel 37 may also include set screws 39 that assist in holding lens assembly 12 in position within mounting device 30. First and second rails 32 and 36 may include set screws 34 to hold mounting assembly 30 (and lens assembly 12) in place on the weapon. For example, U-Shaped channel 38 may slide onto under-carriage 7 of barrel 7 of hand gun 5, wherein optional set screws 34 may be tightened to hold mounting device 30 in place along the barrel.

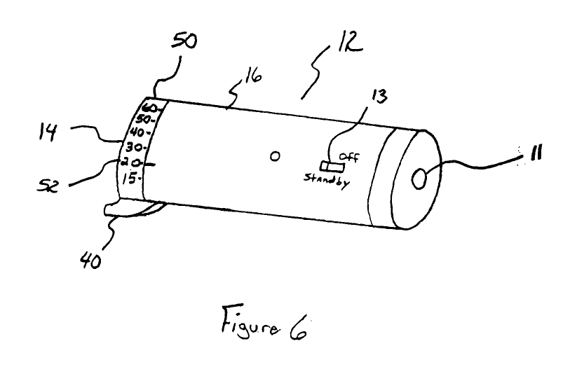

In another exemplary embodiment, the mounting device may be configured to mount lens assembly 12 to a bow at the riser where a stabilizer is generally mounted to the bow. Lens assembly 12 may be configured to be mounted to the bow at this location in place of the stabilizer or in conjunction with a stabilizer such as a modular stabilizer. In another exemplary embodiment, lens assembly 12 may include a threaded receptacle 11 (FIG. 6) positioned on an end opposite lens 14 that is configured to threadingly attach lens assembly 12 to an archery assembly (e.g., a stabilizer or stabilizer mount). Mounting assembly 30 may comprise a variety of other known and yet-to-be developed devices to removably mount, connect, and/or attached lens assembly 12 to a variety of the weapons.

As set forth above, video camera system 10 may also include video camera 20 that is separate from lens assembly 12. Video camera 20 may include a body 22, a wireless receiver 26 connected to body 22, a storage medium 28 in communication with receiver 26, a video display panel 24 in communication with receiver 26 and/or storage medium 28, and a power source (not shown) configured to provide power to video camera 20 and any and/or all of video camera system's 10 other components. Body 22 may be fabricated from a variety of materials such as plastics, metals, composites, or any combination thereof and comprise a variety of shapes and sizes as known to one of ordinary skill in the art. In the exemplary embodiment, video camera 20 is configured to be removably attached to or held by an operator of the combined video camera system 10 and the weapon. For example, video camera 20 may be removably attached to the operator using a variety of conventional devices and techniques such as a clip (not shown) connected to a face of body 22. Such a clip may be the same as or similar to the clips used to attach cell phones, personal data assistants, etc., to a waist band of the pants or belt of a user and need not be described herein.

Video camera 20 may include a variety of input/output jacks and/or connections 25 such as analog, RCA, S-video, USB, FIRE WIRE, or any other conventional input/output jacks or connections for playing, relaying, transferring, downloading, and/or uploading data as known to one of ordinary skill in the art. As set forth above, video camera 20 may also include standard control buttons 21 to permit the operator to play, re-play, stop, pause, record, etc., the images from the storage medium and/or to turn the camera “On” or “Off” as found with conventional video camera systems.

Receiver 26 may be a conventional wireless receiver such as a wireless radio or transceiver to transmit and/or receive data and control signals to and/or from transmitter 18 of lens assembly 12, respectively. Such signals may include, but are not limited to, audio, text, control, still image data, and/or video image data as known to one of ordinary skill in the art. Video camera 20 may also include a signal processor (not shown) in order to receive and process the signals transmitted between lens assembly 12 and video camera 20 as known to one of ordinary skill in the art. Receiver 26 may be in communication with storage medium 28 in order to transmit the data signals (e.g., video and/or audio) received from the transmitter 18 to storage medium 28 in order to store/record them on storage medium 28. Storage medium 28, as used herein, may comprise a variety of storage and/or recording mediums, both analog and digital, such as analog tape, mini digital video tape, CD, DVD, removable storage devices (e.g., compact flash cards, XD memory cards, memory sticks, etc.), or any other storage and/or recording mediums as known to one of ordinary skill in the art.

In the exemplary embodiment, transmitter 18 and receiver 26 use conventional radio frequency (hereinafter “RF”) signals, protocols, and methods to transmit data and control signals wirelessly between lens assembly 12 and video camera 20 as known to one of ordinary skill in the art. Exemplary wireless communications that may be used with the present invention include, but are not limited to, WIFI (e.g., IEEE 802.11), BLUETOOTH, etc. Other wired or wireless technologies may be used with the present invention as well such as infrared, fiber optic, traditional wired connectivity, etc.

In the exemplary embodiment, video camera 20 includes a video display panel 24 attached to a front face 21 of body 22 and configured to display video and/or still images taken (captured) by lens 14 of lens assembly 16 and wirelessly transmitted to video camera 20 via transmitter 18 and received by receiver 26. Video display panel 24 may comprise a LCD panel used in video cameras. Video display panel 24 may alternatively comprise plasma panels or other types of display technologies used in monitors as known to one of ordinary skill in the art.

In another exemplary embodiment, lens assembly 12 may include some or all of the components set forth above and a dial 50 that is rotatably connected to housing 16 of lens assembly 12 as shown in FIG. 6. Dial 50 may include yardage indicators 52 such as 15, 20, 30, 40, 50, 60 or any other yardage indicator marked around the circumference of the dial that signify the zoom/focus required to properly video (or take a still picture of) an object that is approximately that number of yards away from lens assembly 12. For example, if an operator of weapon 5, sees a deer that is approximately 20 yards away, the operator can rotate dial 50 to the yard indicator as shown in FIG. 6. Such rotation to the 20 yard indicator will adjust the lens' (14) zoom and/or focus appropriate for videoing an object approximately 20 yards away.

Lens assembly 12, including lens 14, and dial 50 may be configured such that when dial 14 is rotate to one of a specified number of yardage indicators 52, lens assembly 12 adjusts the zoom (magnification) of the lens appropriate for videoing (or taking a still photograph) of an object that is that approximate distance from the lens assembly. Such a dial zoom adjustment is particularly useful when lens assembly 12 is mounted to a rifle, bow, or cross bow, wherein the target and thus the object desired to be videoed is generally a large distance (e.g., greater than 15 yards).

In yet another exemplary embodiment of the video camera system of the present invention, video camera 20 may include a security or supervisory function to permit only authorized individuals to download and/or view the data (e.g., video images) stored on the storage medium of the video camera 20. For example, such supervisory functionality may prevent the operator of the weapon from viewing, downloading, and/or editing the data recorded or stored onto storage medium 28 and only permit a supervisor to perform such tasks. In an exemplary embodiment of such a video camera system, video camera 20 may not include video display panel 24 in order to assist in preventing non-authorized persons from viewing the data. Video camera 20 may be configured (e.g., programmed using conventional software) to require a password to be entered into the camera to initiate downloading of the data from storage medium 28 to a external device such as a computer or other viewing device. The external device may be configured to only permit viewing of the data upon entry of a password to prevent unauthorized viewing and/or editing of the data. Alternatively, video camera 20 may include video display panel 24 but be configured (e.g., programmed) to require the entry of a password before permitting the viewing and/or editing of the data from storage medium 28 on video display panel 24.

Although the exemplary embodiments of the video camera system for a weapons have been shown and described with a lens assembly for mounting to a weapon and a video camera separate from the lens assembly, it should be understood that the video camera system may comprise a system, wherein the lens assembly and video camera are a single integral unit that may be mounted to a weapon, such as a barrel of a gun. In one exemplary embodiment, video camera system may be a digital video camera system with a 2 gigabyte memory card such as a video IPOD that is configured to be mounted to a weapon such as a barrel of a gun or integrated with a hand gun, handle plate. Alternatively, a lens could be connected to the video camera using a fiber optic line, wherein the lens may be mounted or integrated to the handle of the hand gun and the lens may be mounted to the barrel.

Accordingly, while some of the alternative embodiments of the present invention have been discussed specifically, other embodiments will be apparent or relatively easily developed by those of ordinary skill in the art. Accordingly, this invention is intended to embrace all alternatives, modifications and variations that have been discussed herein, and others that fall within the spirit and broad scope of the claims.

What is claimed is:

1. A camera system for use with a weapon, comprising:
a camera having
a body,
a wireless receiver disposed along the body, and
a storage medium in communication with the receiver; and
a lens assembly separate from the camera and having a wireless transmitter for transmitting signals from the lens assembly to the receiver;
a mount attached to the lens assembly for mounting the lens assembly to a weapon.

2. The camera according to claim 1, further comprising a sensor connected to the lens assembly for activating the camera system.

3. The camera according to claim 2, wherein the sensor is configured to detect a change in the position of the lens assembly from a non-shooting position to a shooting position and based upon detection of this change in positions activate the camera system.

4. The camera according to claim 2, wherein the sensor is a photocell that activates the camera system when it detects light and deactivates the camera system when it does not detect light.

5. The camera according to claim 2, wherein the sensor comprises a motion sensor connected to the lens assembly for detecting motion of the lens assembly, and wherein the camera system is activated when motion of the lens assembly is detected.

6. The camera according to claim 1, further comprising a switch configured to activate the camera system when the lens assembly is partially rotated about a latitudinal axis of the weapon.

7. The camera according to claim 6, wherein the lens assembly is mounted to a hand gun and the switch is configured to activate the camera system when the hand gun is rotated from a holstered position to an un-holstered position.

8. The camera according to claim 6, wherein the switch is configured to activate recording by the camera when the weapon is rotated about the latitudinal axis greater than or equal to about 5° degrees.

9. The camera according to claim 6, wherein the switch is configured to activate recording by the camera when the weapon is rotated about the latitudinal axis greater than or equal to about 30° degrees.

10. The camera according to claim 6, wherein the switch is a mercury switch.

11. The camera according to claim 1, wherein the lens assembly comprises an U-Shaped channel configured to slidably engage an under-carriage of a barrel of a gun.

12. The camera according to claim 11, wherein the U-Shaped channel includes a bottom panel, a first rail, and a second rail disposed opposite the first rail, forming the U-Shaped channel that engages the under-carriage of the barrel.

13. The camera according to claim 1, further comprising a microphone disposed along lens assembly and in communication with the lens transmitter such that audio signals may be wirelessly transmitted from the microphone to the receiver of the camera.

14. The camera according to claim 1, further comprising a video display screen disposed along the camera body.

15. The camera according to claim 1, wherein the camera body configured to be removably attached to an operator.

16. The camera according to claim 1, wherein the lens assembly includes a dial rotatable around a longitudinal axis of the lens assembly, and wherein the dial includes yardage indicators for adjusting the zoom of the lens.

17. The camera according to claim 1, wherein the lens assembly having a back end opposite a lens of lens assembly, wherein the back end includes a threaded receptacle configured to threadingly engage an archery assembly.

18. The camera according to claim 1, wherein the signals comprise video image data.

19. A video camera system for use with a weapon, comprising:
a video camera having a body and a storage medium;
a lens assembly separate from the camera and in communication with the video camera, wherein the lens assembly has a latitudinal axis;
a mount attached to the lens assembly for mounting the lens assembly to a weapon; and
a sensor configured to activate videoing of objects by the video camera system when the lens assembly is partially rotated about the latitudinal axis.

20. The video camera system according to claim 19, wherein the mount is attached a barrel of a hand gun.

21. A wireless video camera system for use with a weapon, comprising:
a video camera having
a body,
a storage medium, and
a first wireless transceiver in communication with the storage medium; and
a lens assembly separate from the video camera and having
a housing,
a lens connected to the housing,
a microphone attached to the housing, and
a second wireless transceiver in communication with the lens and microphone in order to receive respective video and audio signals; and
a mount attached to the lens assembly for mounting the lens assembly to a weapon;
wherein the first and second transceivers are operable to wirelessly transmit and receive video, audio, and control signals between the video camera and the lens assembly.

22. The video camera system according to claim 21, further comprising a tilt switch configured to activate videoing of objects by the video camera system when the lens assembly is partially rotated about a latitudinal axis of the lens assembly.

23. A video camera system in combination with a weapon, comprising:
a weapon;
a lens assembly removably mounted to the weapon and including a lens and a first wireless transceiver in communication with the lens;
a video camera separate from the lens assembly and having a second wireless transceiver and a storage medium in communication with the second transceiver;
wherein the first and second transceivers wirelessly transmits and receive signals between and from the lens assembly and the video camera in order to video objects within the viewing range of the lens.

24. The video camera system in combination with a weapon according to claim 23, further comprising a switch configured to activate the video camera when the weapon is partially rotated about a latitudinal axis of the weapon.
